(19) United States
(12) Patent Application Publication
(10) Pub. No.: US 2025/0379617 A1
(43) Pub. Date: Dec. 11, 2025

(54) INTELLIGENT REFLECTING SURFACE

(71) Applicant: Japan Display Inc., Tokyo (JP)

(72) Inventors: Masayuki IKARI, Tokyo (JP); Shinichiro OKA, Tokyo (JP); Mitsutaka OKITA, Tokyo (JP); Daiichi SUZUKI, Tokyo (JP); Kazuki MATSUNAGA, Tokyo (JP)

(73) Assignee: Japan Display Inc., Tokyo (JP)

(21) Appl. No.: 19/246,745

(22) Filed: Jun. 24, 2025

Related U.S. Application Data
(63) Continuation of application No. PCT/JP2023/041036, filed on Nov. 15, 2023.

(30) Foreign Application Priority Data
Jan. 25, 2023 (JP) 2023-009575

(51) Int. Cl. H04B 7/04

(52) U.S. Cl. CPC H04B 7/04013

(57) ABSTRACT

An intelligent reflecting surface in one embodiment includes a plurality of patch electrodes and a common electrode opposite to the plurality of patch electrodes and a liquid crystal layer between the plurality of patch electrodes and the common electrode, wherein the plurality of patch electrodes has a first patch electrode and a second patch electrode adjacent to the first patch electrode, a first distance between the first patch electrode and the common electrode is shorter than a second distance between the second patch electrode and the common electrode, the first distance is a distance from a first surface of the first patch electrode to a surface opposite the first patch electrode of the common electrode, and the second distance is a distance from a first surface of the second patch electrode to a surface opposite the second patch electrode of the common electrode.

### CROSS-REFERENCE TO RELATED APPLICATIONS

This application is a Continuation of International Patent Application No. PCT/JP2023/041036, filed on Nov. 15, 2023, which claims the benefit of priority to Japanese Patent Application No. 2023-009575, filed on Jan. 25, 2023, the entire contents of each are incorporated herein by reference.

### FIELD

An embodiment of the present invention relates to an intelligent reflecting surface (radio-wave reflective device).

### BACKGROUND

A phased array antenna device controls the directivity of a high-frequency signal in a state in which the antenna is fixed by adjusting the amplitude and phase of the high-frequency signal to be applied to each of a plurality of antenna elements arranged in a planar shape. The phased array antenna device requires a phase shifter. A phased array antenna device using a phase shifter that utilizes changes in a dielectric constant due to the orientation state of liquid crystals is disclosed (see, for example, Japanese laid-open patent publication No. 2019-530387).

The radio-wave reflective device described above has a limit in a controllable range (a range in which a traveling direction of a radio wave can be adjusted) even if an orientation state of a liquid crystal is changed to the maximum extent, and it is not capable of responding to all directions. Therefore, if it is desired to supply radio waves to an area outside the controllable range of the radio-wave reflective device, it was necessary to adjust a direction of a reflective surface (action surface) of the radio-wave reflective device in advance and set it so that the area falls within the controllable range of the radio-wave reflective device. It is necessary to orient the reflective surface of the radio-wave reflective device in the desired direction, regardless of the environment in which the radio-wave reflective device is installed.

### SUMMARY

An intelligent reflecting surface in one embodiment of the present invention includes a plurality of patch electrodes, a common electrode opposite the plurality of patch electrodes, and a liquid crystal layer between the plurality of patch electrodes and the common electrode, wherein the plurality of patch electrodes comprises a first patch electrode and a second patch electrode adjacent to the first patch electrode, a first distance between the first patch electrode and the common electrode is shorter than a second distance between the second patch electrode and the common electrode, the first distance is a distance from a first surface opposite the common electrode of the first patch electrode to a surface opposite the first patch electrode of the common electrode, and the second distance is a distance from a first surface opposite the common electrode of the second patch electrode to a surface opposite the second patch electrode of the common electrode.

### BRIEF DESCRIPTION OF THE DRAWINGS

FIG. 1 is a plan view showing a configuration of a radio-wave reflective device of one embodiment of the present invention.

FIG. 2A is a plan view showing a configuration of a reflecting element in a radio-wave reflective device of one embodiment of the present invention.

FIG. 2B is a cross-sectional view showing a configuration of a reflecting element in a radio-wave reflective device of one embodiment of the present invention.

FIG. 3A is a diagram showing an operating state of a reflecting element in a radio-wave reflective device of one embodiment of the present invention.

FIG. 3B is a diagram showing an operating state of a reflecting element in a radio-wave reflective device of one embodiment of the present invention.

FIG. 4 is a cross-sectional view showing a configuration of a reflecting element in a radio-wave reflective device of one embodiment of the present invention.

FIG. 5 is a cross-sectional view showing a configuration of a reflecting element in a radio-wave reflective device of one embodiment of the present invention.

FIG. 6 is a schematic diagram for explaining a traveling direction of a reflected wave in a control state in the radio-wave reflective device of one embodiment of the present invention.

FIG. 7 is a cross-sectional view showing a configuration of a reflecting element in a radio-wave reflective device of one embodiment of the present invention.

FIG. 8 is a cross-sectional view showing a configuration of a reflecting element in a radio-wave reflective device of another embodiment of the present invention.

FIG. 9 is a cross-sectional view showing a configuration of a reflecting element in a radio-wave reflective device of another embodiment of the present invention.

FIG. 10A is a cross-sectional view showing a method for manufacturing a radio-wave reflective device of one embodiment of the present invention.

FIG. 10B is a cross-sectional view showing a method for manufacturing a radio-wave reflective device of one embodiment of the present invention.

FIG. 10C is a cross-sectional view showing a method for manufacturing a radio-wave reflective device of one embodiment of the present invention.

FIG. 10D is a cross-sectional view showing a method for manufacturing a radio-wave reflective device of one embodiment of the present invention.

FIG. 10E is a cross-sectional view showing a method for manufacturing a radio-wave reflective device of one embodiment of the present invention.

FIG. 11A is a cross-sectional view showing a method for manufacturing a radio-wave reflective device of one embodiment of the present invention.

FIG. 11B is a cross-sectional view showing a method for manufacturing a radio-wave reflective device of one embodiment of the present invention.

FIG. 11C is a cross-sectional view showing a method for manufacturing a radio-wave reflective device of one embodiment of the present invention.

FIG. 11D is a cross-sectional view showing a method for manufacturing a radio-wave reflective device of one embodiment of the present invention.

FIG. 11E is a cross-sectional view showing a method for manufacturing a radio-wave reflective device of one embodiment of the present invention.

FIG. 11F is a cross-sectional view showing a method for manufacturing a radio-wave reflective device of one embodiment of the present invention.

FIG. 11G is a cross-sectional view showing a method for manufacturing a radio-wave reflective device of one embodiment of the present invention.

FIG. 11H is a cross-sectional view showing a method for manufacturing a radio-wave reflective device of one embodiment of the present invention.

FIG. 12A is a cross-sectional view showing a method for manufacturing a radio-wave reflective device of one embodiment of the present invention.

FIG. 12B is a cross-sectional view showing a method for manufacturing a radio-wave reflective device of one embodiment of the present invention.

FIG. 12C is a cross-sectional view showing a method for manufacturing a radio-wave reflective device of one embodiment of the present invention.

FIG. 12D is a cross-sectional view showing a method for manufacturing a radio-wave reflective device of one embodiment of the present invention.

FIG. 13 shows a plan view of a radio-wave reflective device of one embodiment of the present invention.

FIG. 14 is a cross-sectional view of a reflecting element in a radio-wave reflective device of one embodiment of the present invention.

### DESCRIPTION OF EMBODIMENTS

Hereinafter, an embodiment of the present invention will be described with reference to the drawings, and the like. However, the invention can be implemented in many different ways and is not to be interpreted as limited to the description of the embodiments shown below. Although the drawings may be schematically represented in terms of width, thickness, shape, and the like of each part compared to the actual embodiment in order to make the description clearer, this is only an example and does not limit the interpretation of the invention.

In this specification and in each figure, elements similar to those described above with respect to the figures already mentioned may be marked with the same reference sign and detailed explanations may be omitted as appropriate. For convenience of explanation, elements having a common function may be distinguished by adding the letters “a”, “b”, or the like after the same sign. However, in the case where there is no particular need to distinguish between them, they may be explained with the same reference sign. Furthermore, the terms “first” and “second” attached to each element are merely labels used for convenience to distinguish each element, and have no other meaning unless otherwise specified.

In the case where this specification refers to one component or area being “above (or below)” another component or area, unless otherwise specified, this includes not only the case where it is directly above (or below) the other component or area, but also the case where it is above (or below) the other component or area, that is, this includes the case where another component is included in between above (or below) the other component or area.

In this specification, unless otherwise specified, expressions such as “a includes A, B, or C” “a includes any of A, B or C”, “a includes one selected from a group consisting of A, B and C” does not exclude the case where a includes a combination of multiple A to C, unless otherwise specified. Furthermore, these expressions do not exclude the case where a includes other elements.

As used herein, a reflecting device (radio wave reflecting device) is also referred to as an IRS (Intelligent Reflecting Surface) or the like.

### First Embodiment

### Configuration of Radio-wave Reflective Device

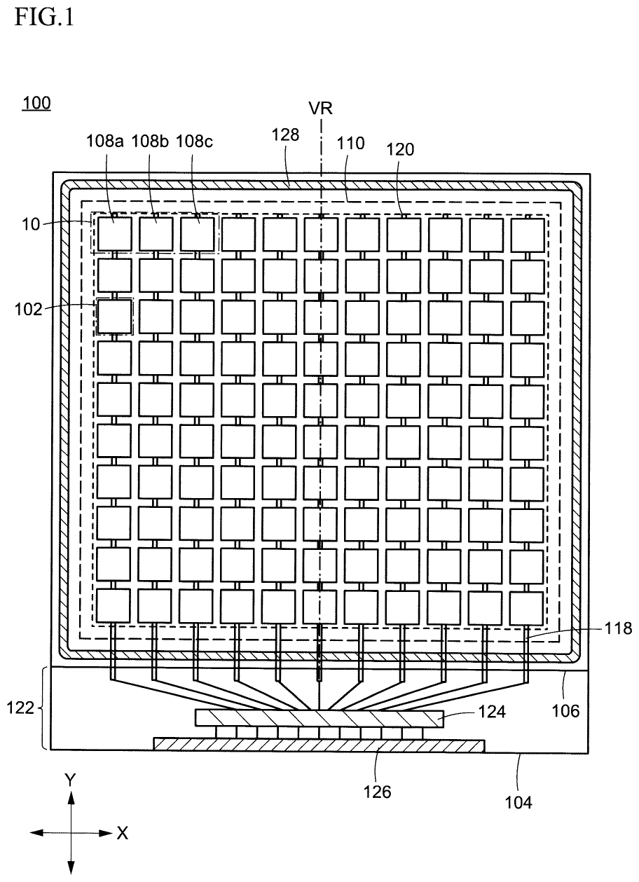

FIG. 1 is a plan view showing a configuration of a radio-wave reflective device 100 of one embodiment of the present invention. The radio-wave reflective device 100 of the present embodiment has a configuration in which an electrode group consisting of a plurality of patch electrodes 108 connected in series in a first direction (Y direction or column direction) is arranged in a row in a second direction (X direction or row direction) that intersects the first direction. In FIG. 1, the first direction (up and down direction when facing the drawing) corresponds to a column direction, and the second direction (left and right direction when facing the drawing) corresponds to a row direction. In the present embodiment, an example will be described in which one-dimensional control is performed by using the plurality of patch electrodes 108 connected in the first direction to change a traveling direction of a reflected wave in the second direction with a reflection axis VR as a rotation axis.

As shown in FIG. 1, the radio-wave reflective device 100 has a reflector 120. The reflector 120 is composed of a plurality of reflecting elements 102. The plurality of reflecting elements 102 in the present embodiment are arranged in a matrix in the first and second directions described above. The specific structure of the reflecting element 102 is described below. The reflecting elements 102 are arranged so that the plurality of patch electrodes 108 face a plane of incidence of radio waves. The reflector 120 is a flat plate-shaped structure composed of the plurality of reflecting elements 102, and a traveling direction of the radio waves (reflected waves) reflected by the reflector 120 is controlled by a voltage applied to each patch electrode 108 and a distance between each of the different patch electrodes 108 and the common electrode 110.

The radio-wave reflective device 100 has a structure in which a plurality of reflecting elements 102 are integrated in one dielectric substrate (dielectric layer) 104. As shown in FIG. 1, the radio-wave reflective device 100 has a structure in which the substrate 104 with a plurality of patch electrodes 108 arranged thereon and a substrate 106 with a common electrode 110 opposite the plurality of patch electrodes 108 are stacked, and a liquid crystal layer (not shown) is provided between the two substrates.

The reflector 120 is formed in a region where the plurality of patch electrodes 108 and the common electrode 110 overlap. The substrate 104 and the substrate 106 are bonded together using a sealing material 128 composed of, for example, a photo-curable resin material. Although not shown in the figure, the liquid crystal layer is provided in the region inside the sealing material 128.

The substrate 104 has a peripheral region 122 extending outward from the substrate 106 in addition to a region facing the substrate 106. The peripheral region 122 is provided with a first drive circuit 124 and a terminal portion 126. The first drive circuit 124 outputs control signals to each patch electrode 108. The terminal portion 126 is a region that functions as a connection portion to an external circuit (not shown) and is connected to, for example, a flexible printed circuit board, which is not shown in the figure. Signals for controlling the first drive circuit 124 are input to the terminal portion 126.

In the reflector 120, the plurality of patch electrodes 108 are connected to the first wiring 118 extending in the first direction. In other words, each patch electrode 108 is interconnected via the first wiring 118. The reflector 120 has a configuration in which a plurality of electrode groups comprising the plurality of patch electrodes 108 connected in the first direction (column direction) by the first wiring 118 are arranged in the second direction (row direction).

The plurality of first wirings 118 extend to the peripheral region 122 and are connected to the first drive circuit 124. The first drive circuit 124 outputs control signals to be supplied to each patch electrode 108. Specifically, the first drive circuit 124 can output control signals of different voltages to each of the plurality of first wirings 118. By supplying different control signals to each of the first wirings 118 (that is, applying different voltages to each first wiring 118), in the reflector 120, different control signals are supplied to each column of the plurality of patch electrodes 108 arranged in the first and second directions (that is, for each electrode group composed of the plurality of patch electrodes 108 arranged in the first direction).

The radio-wave reflective device 100 can control the traveling direction of a reflected wave of the radio waves incident on the reflector 120 by supplying a different control signal to each electrode group consisting of the plurality of patch electrodes 108 arranged in the first direction. In other words, the radio-wave reflective device 100 can change the reflection direction of the radio wave irradiated on the reflector 120 in the left and right directions (row direction) of the drawing centering on the reflection axis VR parallel to the first direction.

### Reflecting Element Configuration

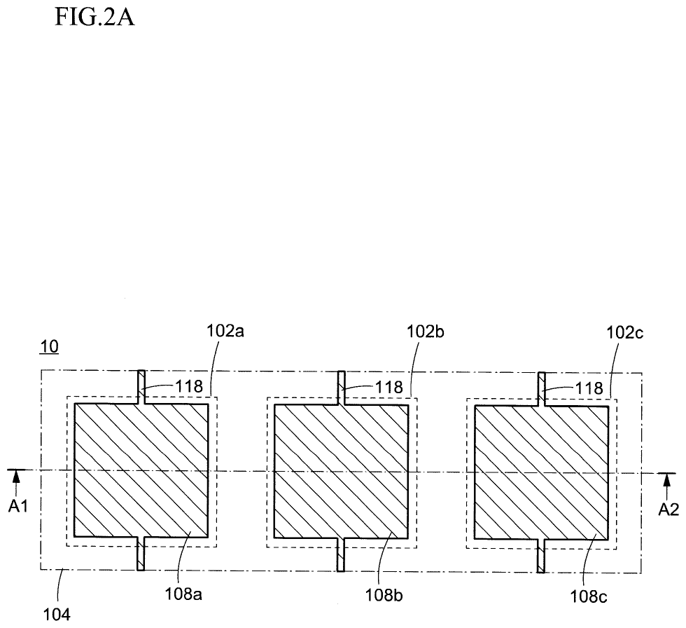

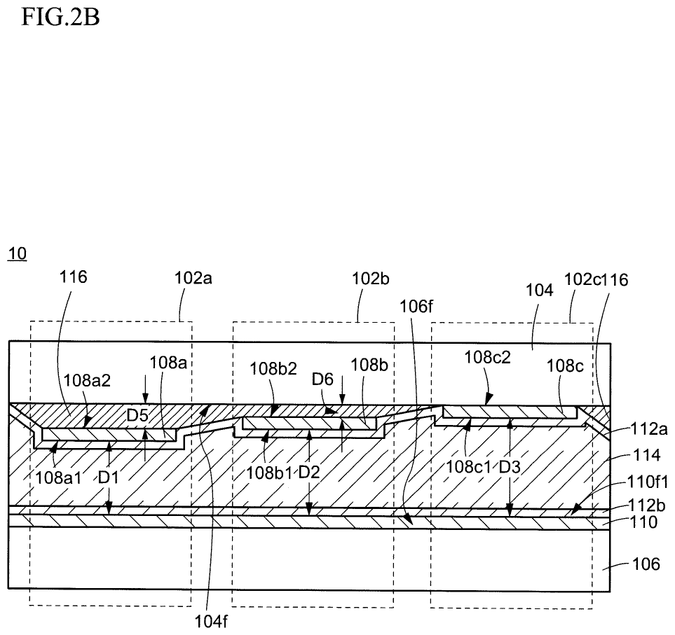

FIG. 2A is a plan view showing the configuration of a reflecting element group of the reflecting element 102 in the radio-wave reflective device 100 of one embodiment of the invention. FIG. 2B is a cross-sectional view showing a configuration of the reflecting element 102 in the radio-wave reflective device 100 of one embodiment of the present invention. Specifically, FIG. 2B corresponds to a cross-sectional view of the reflecting element group 10 of the reflecting element 102 shown in FIG. 2A taken along a line A1-A2.

As shown in FIG. 2A and FIG. 2B, the reflecting element 102 includes the substrate 104, the substrate 106, the patch electrode 108, the common electrode 110, a liquid crystal layer 114, an alignment film 112a, and an alignment film 112b. In addition, in FIG. 2A and FIG. 2B, although the description will be given by referring to the patch electrode 108, unless otherwise specified, the description of the patch electrode 108 is common to the patch electrode 108a, the patch electrode 108b, and the patch electrode 108c.

The patch electrode 108 is provided on the substrate 104. The patch electrode 108 of the substrate 104 is arranged on first surface 104f facing the substrate 106. In the reflecting element 102, the substrate 104 can be regarded as a dielectric layer having a predetermined dielectric constant. It is preferable that the patch electrode 108 has a symmetrical shape. However, the structure such as the interconnection of the patch electrodes may not be limited to this. FIG. 2A shows an example in which the patch electrode 108 is a square in a plan view.

The common electrode 110 is provided on the opposing substrate 106. The common electrode 110 is arranged on a first surface 106f facing the substrate 104 of the substrate 106. There is no particular limitation to the shape of the common electrode 110. The common electrode 110 of the present embodiment is provided over substantially the entire surface of the substrate 106 so as to face the plurality of patch electrodes 108.

There is no particular limitation on the materials used to form each patch electrode 108 and the common electrode 110, which may be composed of a conductive metal material or a metal oxide material. Additionally, a material that reflects visible light may be used for each patch electrode 108 and common electrode 110. Furthermore, a material with low resistivity may be used to form the patch electrode 108. For example, the material forming the common electrode 110 may be a metal film such as aluminum (Al) or copper (Cu).

The first alignment film 112a is provided to cover the patch electrode 108. The alignment film 112b is provided to cover the common electrode 110. The patch electrode 108 and the common electrode 110 are arranged to face each other with the liquid crystal layer 114 interposed therebetween. The alignment film 112a is interposed between the patch electrode 108 and the liquid crystal layer 114, and the alignment film 112b is interposed between the common electrode 110 and the liquid crystal layer 114.

Although not shown in FIGS. 2A and 2B, the liquid crystal layer 114 is provided in a region surrounded by the sealing material 128, as shown in FIG. 1, and is provided so as to fill a gap between the substrate 104 and the substrate 106.

A space between the substrate 104 and the substrate 106 is 30 to 100 μm, for example, 50 μm. Since the patch electrode 108, the common electrode 110, the alignment film 112a, and the alignment film 112b are arranged between the substrate 104 and the opposing substrate 106, a distance between the alignment film 112a and the alignment film 112b on each of the substrate 104 and the opposing substrate 106 is precisely a thickness of the liquid crystal layer 114. In addition, although not shown in FIG. 2B, a spacer may be provided between the substrate 104 and the opposing substrate 106 to keep the spacing constant.

As shown in FIG. 1, the substrate 104 has a first wiring 118 that is connected to the patch electrode 108. In the present embodiment, although the first wiring 118 is integrally formed with the patch electrode 108, it is not limited to this example. That is, the first wiring 118 and the patch electrode 108 may be formed as separate elements and electrically connected to each other. The patch electrodes 108a to 108c shown in FIG. 2A are connected to other adjacent patch electrodes 108 via the first wiring 118 as shown in FIG. 1.

A control signal is supplied to the patch electrode 108 to control orientation of liquid crystal molecules in the liquid crystal layer 114. The control signal is a DC voltage signal or a polarity reversal signal that alternately reverses between positive and negative DC voltages. A ground voltage or a middle level voltage of a polarity inversion signal is applied to the common electrode 110. When a control signal is supplied to the patch electrode 108, an orientation state of the liquid crystal molecules in the liquid crystal layer 114 changes.

As the liquid crystal layer 114, a liquid crystal material having an anisotropic dielectric constant is used. For example, nematic, smectic, cholesteric, or discotic liquid crystals can be used as the liquid crystal layer 114. The liquid crystal layer 114 has dielectric anisotropy, and the dielectric constant changes with the change in the orientation state of the liquid crystal molecules. The reflecting element 102 can delay a phase of reflected waves when reflecting radio waves by changing the dielectric constant of the liquid crystal layer 114 using a control signal supplied to the patch electrode 108 (that is, a voltage applied to the patch electrode 108).

Frequency bands of the radio waves reflected by the reflecting element 102 are a very high frequency (VHF) band, an ultra-high frequency (UHF) band, a super high frequency (SHF) band, a submillimeter wave (THF: Tremendously high frequency) band, and a millimeter wave (EHF: Extra High Frequency) band. Although the orientation of the liquid crystal molecules in the liquid crystal layer 114 changes in response to the control signal supplied to the patch electrode 108, it hardly follows the frequency of the radio waves irradiated to the patch electrode 108. Therefore, the reflecting element 102 can control the phase of the reflected radio waves without being affected by the radio waves.

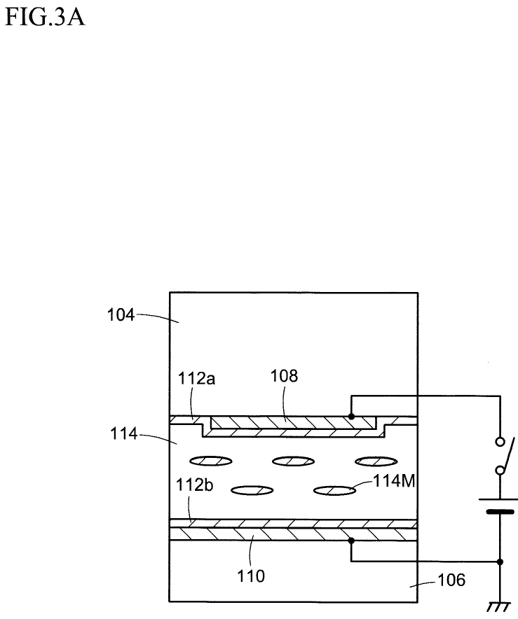

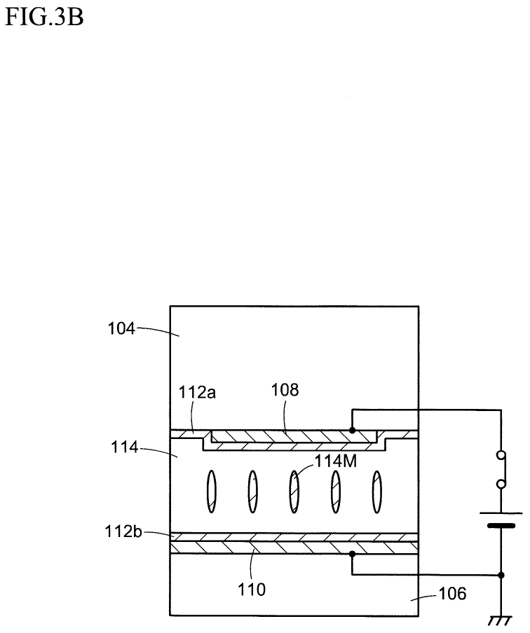

Referring now to FIGS. 3A and 3B, the orientation state of the liquid crystal layer 114 when a voltage is applied to the patch electrode 108 and the common electrode 110 of the reflecting element 102 is explained.

FIG. 3A shows a state in which no control signal is supplied to the patch electrode 108 (hereinafter referred to as “a first state”). FIG. 3A shows a case where the alignment film 112a and the alignment film 112b are both horizontally oriented films. The long axis of the liquid crystal molecules 114M in the first state is horizontally oriented with respect to the surface of the patch electrode 108 and the common electrode 110 by the alignment film 112a and the alignment film 112b. FIG. 3B shows a state in which a control signal (voltage signal) is applied to the patch electrode 108 (hereinafter referred to as a “second state”). In the second state, the liquid crystal molecules 114M receive the action of the electric field to align the long axis perpendicularly to the surface of the patch electrode 108 and the common electrode 110. An angle at which the long axes of the liquid crystal molecules 114M are oriented can be set to an intermediate direction between the horizontal and vertical directions depending on the magnitude of the control signal applied to the patch electrode 108 (the magnitude of the voltage between the counter electrode and the patch electrode).

When the liquid crystal molecules 114M have positive dielectric anisotropy, the dielectric constant of the second state is greater than that of the first state. Furthermore, when the liquid crystal molecules 114M have negative dielectric anisotropy, the apparent dielectric constant of the second state becomes smaller than that of the first state. The liquid crystal layer 114 having dielectric anisotropy may also be regarded as a variable dielectric layer. The reflecting element 102 can control such that the phase of the reflected wave is delayed (or not delayed) using the dielectric anisotropy of the liquid crystal layer 114.

Referring again to FIGS. 2A and 2B, the distance between the thickness of the liquid crystal layer 114 and the common electrode 110 will be described, and the control of the reflecting element 102 will be described.

The thickness of the liquid crystal layer 114 differs between adjacent patch electrodes 108 and the common electrode 110. Specifically, as shown in FIG. 2B, the thickness of the liquid crystal layer 114 differs between the adjacent patch electrodes 108a and 108b and the common electrode 110. Similarly, the thickness of the liquid crystal layer 114 between the adjacent patch electrodes 108b and 108c and the common electrode 110 is also different.

Furthermore, the distance between adjacent patch electrodes 108 and the common electrode 110 is different. For example, as shown in FIG. 2B, a distance D1 between the patch electrode 108a and the common electrode 110 is different from a distance D2 between the adjacent patch electrode 108b and the common electrode 110. Specifically, the distance D1 is shorter than the distance D2. In other words, the distance D2 is longer than the distance D1.

The distance D1 indicates the distance from a surface 108a1 opposite the common electrode 110 of the patch electrode 108a to a surface 110f1 opposite the patch electrode 108a of the common electrode 110. Similarly, the distance D2 indicates the distance from the surface 108b1 opposite the common electrode 110 of the patch electrode 108b to the surface 110f1 opposite the patch electrode 108b of the common electrode 110.

Furthermore, the distance D2 is different from a distance D3 between the adjacent patch electrode 108c and the common electrode 110, as shown in FIG. 2B. Specifically, the distance D2 is shorter than the distance D3. In other words, the distance D3 is longer than the distance D2.

The distance D3 indicates the distance from a surface 108c1 opposite the common electrode 110 of the patch electrode 108c to the surface 110f1 opposite the patch electrode 108c of the common electrode 110.

When the distance between the patch electrode 108 and common electrode 110 differs as in distances D1 to D3, the phase difference of the reflected waves from each of the reflecting elements 102a to 102c differs. The phase difference arisen by the distance between the patch electrode 108 and the common electrode 110 is referred to as the initial phase difference. The initial phase difference of the reflected wave from the reflecting element 102a at the distance D1 is smaller than that of the reflected wave from the reflecting element 102b at the distance D2 because the distance D1 is shorter than the distance D2. The initial phase difference of the reflected wave from the reflecting element 102b at the distance D2 is smaller than that of the reflected wave from the reflecting element 102c at the distance D3 because the distance D2 is shorter than the distance D3. Furthermore, when varying distances D1 to D3 as one cycle, for example, the phase difference at 0° for the reflecting element 102a at the distance D1, the phase difference at 120° for the reflecting element 102b at the distance D2, and the phase difference at 240° for the reflecting element 102c at the distance D3 are set by adjusting the distances D1 to D3.

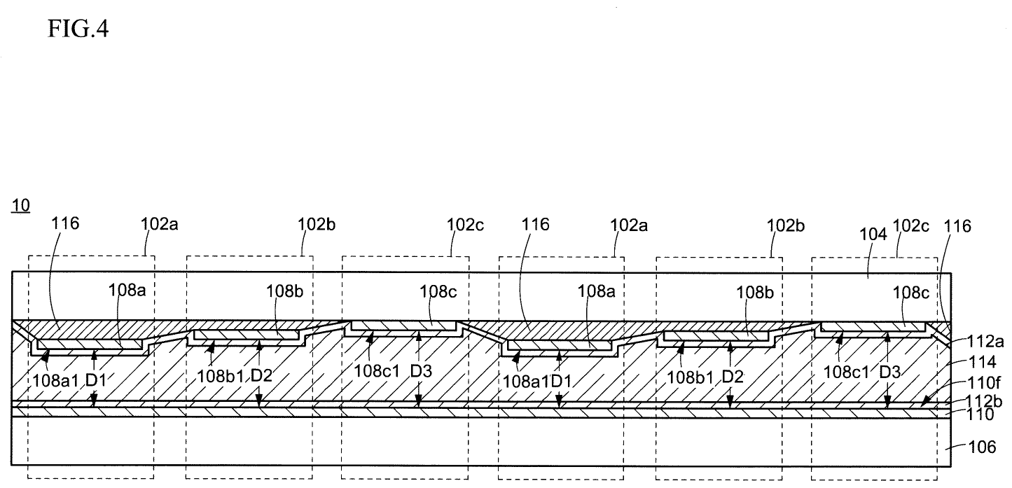

When varying the distance between the patch electrode 108 and the common electrode 110 over a plurality of cycles, with distances D1 to D3 as one cycle, as shown in FIG. 4, the reflecting element 102a with the distance D1 is arranged next to the reflecting element 102c with the distance D3. FIG. 4 is a cross-sectional view showing the configuration of the reflecting elements in the radio-wave reflective device of one embodiment of the present invention.

The distance between the patch electrode 108 and the common electrode 110 varies from distance D1 to distance D3 between the patch electrode 108a and the patch electrode 108c, as shown in FIG. 4, and the variation from distance D1 to distance D3 with respect to the patch electrodes 108a to 108c repeats. As described above, at this time, the phase difference for the reflecting element 102a at distance D1 is 0°, the phase difference for the reflecting element 102b at distance D2 is 120°, and the phase difference for the reflecting element 102c at distance D3 is 240°, and the phase difference for the reflecting element 102a at distance D1, which is adjacent to the reflecting element 102c at the distance D3, is) 0° (360°).

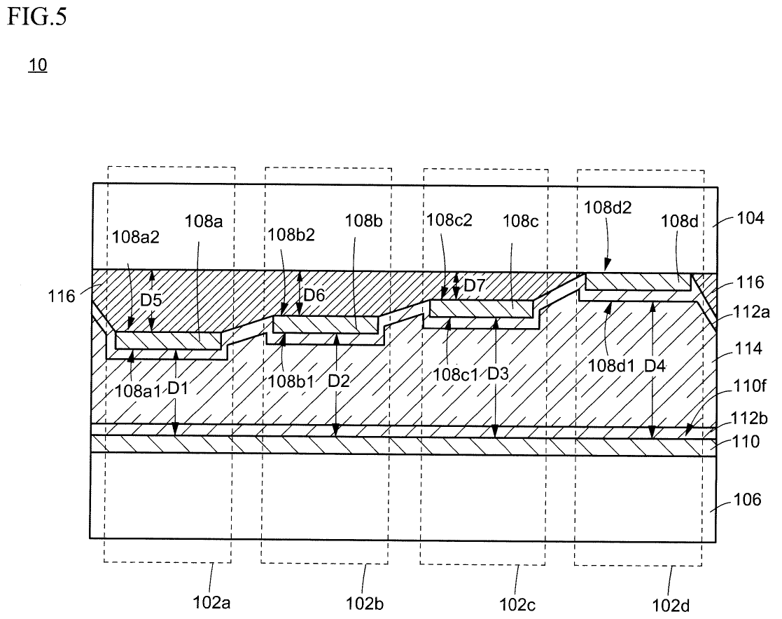

FIG. 4 shows an example of using three different distance changes, such as the distance D1 to distance D3, but it is possible to use a plurality of types of different distance changes, not just three types. For example, as shown in FIG. 5, it is possible to use four different distance variations. FIG. 5 is a cross-sectional view showing the configuration of the reflecting element in the radio-wave reflective device of one embodiment of the present invention.

As shown in FIG. 5, the distance between the patch electrode 108 and the common electrode 110 can be varied over a plurality of cycles by gradually varying the distance from the shortest distance D1 to the longest distance D4 among the four different distances, with the distance D1 to D4 constituting one cycle. By varying the distance between the patch electrode 108 and the common electrode 110 over a plurality of cycles, the thickness of the liquid crystal layer 114 can also be varied periodically between each set of the patch electrode 108 and the common electrode 110.

The phase differences of the reflected waves from each of the reflecting elements 102a to 102d at distances D1 to D4 are also different from each other, as described above for the reflecting elements 102a to 102c. The phase differences of the reflecting elements 102a to 102c have the magnitude relationship as described above, and furthermore, the phase difference of the reflected wave from the reflecting element 102d at the distance D4 is larger than the phase difference of the reflected wave from the reflecting element 102c at the distance D3. At this time, the distances D1 to D4 are set so that the phase difference for the reflecting element 102a is 0°, the phase difference for the reflecting element 102b is 90°, the phase difference for the reflecting element 102c is 180°, the phase difference for the reflecting element 102d at the distance D4 is 240°, and the phase difference for the reflecting element 102a at the distance D1, which is adjacent to the reflecting element 102d at the distance D4 (not shown), is) 0° (360°).

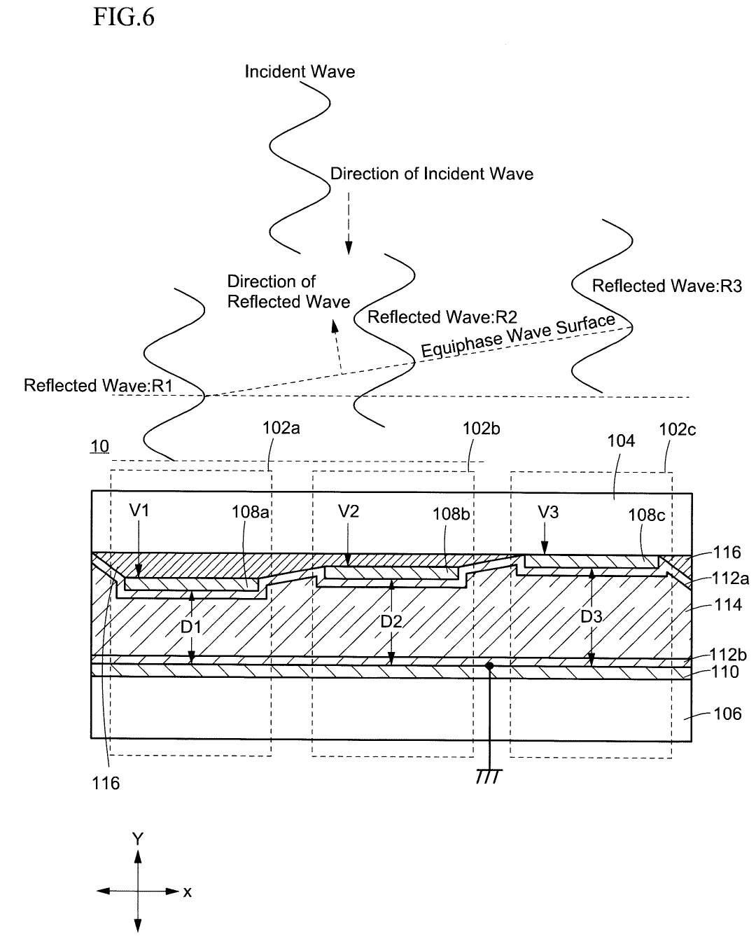

Here, referring to FIG. 6, we will explain how varying the distance between the patch electrode 108 and the common electrode 110 provides an initial phase difference in the reflected waves from each reflecting element 102. FIG. 6 is a schematic diagram explaining a traveling direction of a reflected wave in the control state of the radio-wave reflective device according to one embodiment of the present invention.

FIG. 6 schematically shows that the traveling direction of the reflected wave changes due to three reflecting elements 102, where the distance between the patch electrode 108 and the common electrode 110 is the distance D1 to the distance D3. When radio waves are incident on the reflecting elements 102a to 102c with the same phase, since different control signals (V1≠V2≠V3) are applied to each of the reflecting elements 102a to 102c, the phase difference of the reflected wave from the reflecting element 102b is larger than that from the reflecting element 102a, and the phase difference of the reflected wave from the reflecting element 102c is larger than that from the reflecting element 102b.

Furthermore, since the distance between the patch electrode 108 and the common electrode 110 differs between the reflecting elements 102a to 102c, when radio waves with the same phase are incident on the reflecting elements 102a to 102c, the initial phase difference between the reflected waves from the reflecting elements 102a to 102c differs. Specifically, this shows a case where the phase difference of the reflected wave from the reflecting element 102b at the distance D2 is larger than the phase difference of the reflected wave from the reflecting element 102a at the distance D1, and the phase difference of the reflected wave from the reflecting element 102c at the distance D3 is larger than the phase difference of the reflected wave from the reflecting element 102b at the distance D2.

As a result, the phases of the reflected wave R1 reflected by the reflecting element 102a, the reflected wave R2 reflected by the reflecting element 102b, and the reflected wave R3 reflected by the reflecting element 102c are different. For example, in FIG. 6, the phase of the reflected wave R2 is ahead of the phase of the reflected wave R1, and the phase of the reflected wave R3 is ahead of the phase of the reflected wave R2. Furthermore, the phase difference between the reflected wave R1 reflected by the reflecting element 102a and the reflected wave R2 reflected by the reflecting element 102b is the same as the phase difference between the reflected wave R2 reflected by the reflecting element 102b and the reflected wave R3 reflected by the reflecting element 102c. The reflected waves from the reflecting element group 10 have an equiphase wave surface as shown in FIG. 6, and the traveling direction of the reflected waves changes diagonally or vertically with respect to the equiphase wave surface. Furthermore, the traveling direction of the reflected wave can extend beyond the range obtainable by applying a voltage to the reflecting element 102, due to the initial phase difference of the reflected wave from the reflecting element 102.

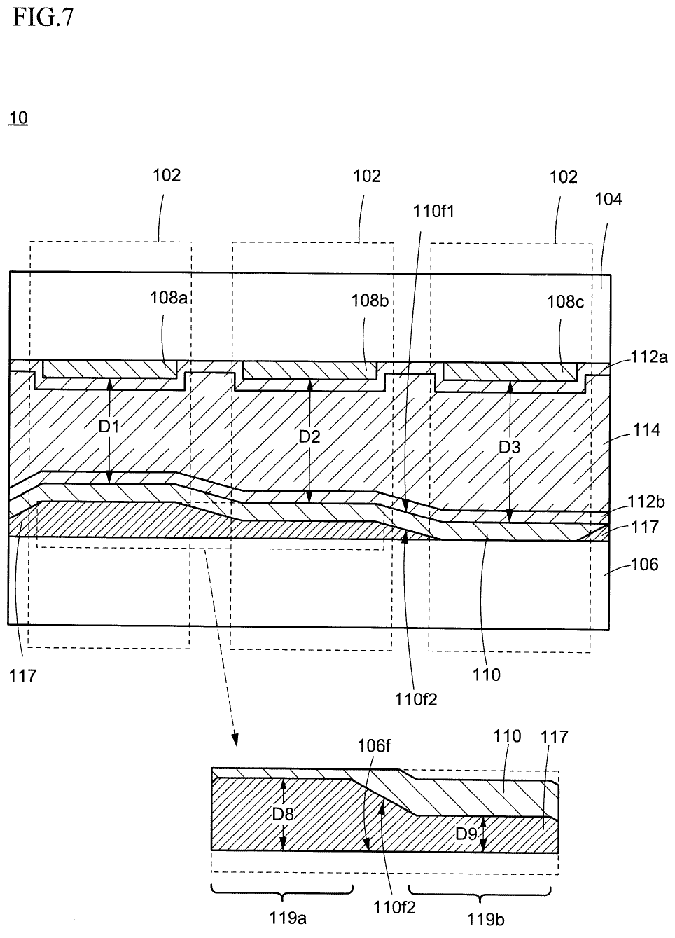

The traveling direction of the reflected wave can be controlled by periodically varying the distance between the patch electrode 108 and the common electrode 110. For example, as shown in FIG. 1, when changing the reflection direction of the reflected wave by the reflecting element 102 in the left-right direction (X direction) of the drawing centered on the reflection axis VR parallel to the first direction, it is sufficient to periodically change the distance between the patch electrode 108 and the common electrode 110 in the left-right direction of the drawing. Additionally, as will be described in detail later, when changing the direction of the reflected waves not only around the reflection axis VR parallel to the first direction but also around the reflection axis HR parallel to the second direction in the vertical direction (Y direction) of the drawing, in addition to the periodic change in the distance between the patch electrode 108 and common electrode 110 in the left-right direction of the drawing, it is also desirable to make a periodic change in the up-down direction of the drawing (see FIG. 7).

The periodic change in the distance between the patch electrode 108 and the common electrode 110 can be adjusted by an insulating layer 116 provided between the patch electrode 108 and the substrate 104. For example, as shown in FIG. 2B, by providing the insulating layer 116 between the patch electrodes 108a and 108b and the substrate 104, the periodic change in the distance between the patch electrode 108 and the common electrode 110 can be adjusted.

Providing the insulating layer 116 between the patch electrode 108a and the substrate 104 separates the patch electrode 108a and the substrate 104, so that the patch electrode 108a and the substrate 104 can be separated by a distance D5. Similarly, by providing the insulating layer 116 between the patch electrode 108b and the substrate 104, the patch electrode 108b and the substrate 104 are separated, and the distance between the patch electrode 108b and the substrate 104 can be set to a distance D6. At this time, the thicknesses of the patch electrodes 108a and 108b are equal or approximately equal, and the distance D5 can be longer than the distance D6. By setting the distance D5 longer than the distance D6, the distance D1 can be set shorter than the distance D2.

Furthermore, the distances D2 and D3 can also be set such that the insulating layer 116 is provided between the patch electrode 108b and the common electrode 110 as described above, while no insulating layer 116 is provided between the patch electrode 108c and the common electrode 110, so that the distance D2 can be made shorter than the distance D3. Alternatively, as shown in FIG. 5, the insulating layer 116 may be provided between the patch electrode 108b and the patch electrode 108c and the substrate 104, and the distances D6 and D7 between the patch electrode 108b and the patch electrode 108c and the substrate 104 may be made different, and the distance D2 may be adjusted to be shorter than the distance D3.

The distances D5 to D7 indicate the distances between the substrate 104 and each patch electrode 108, as described above. Specifically, the distance D5 is the distance from a surface 108a2 opposite to a surface 108a1 of the patch electrode 108a to a first surface 104f of the substrate 104 on which the patch electrode 108a is located. The distance D6 is the distance from the surface 108b2 opposite the surface 108b1 of the patch electrode 108b to the first surface 104f of the substrate 104 on which the patch electrode 108b is positioned above. The distance D7 is the distance from the surface 108c2 opposite the surface 108c1 of the patch electrode 108c to the first surface 104f of the substrate 104 on which the patch electrode 108c is located.

### Modification 1 of First Embodiment

FIG. 2B shows an example in which the insulating layer 116 is provided between the patch electrode 108 and the substrate 104, and the distance between the patch electrode 108 and the common electrode 110 is periodically varied, but this example is not limited to this. For example, the distance between the patch electrode 108 and the common electrode 110 can be periodically varied by an insulating layer 117 provided between the common electrode 110 and the substrate 106.

The periodic change in the distance between the patch electrode 108 and the common electrode 110 can be adjusted by the insulating layer 117 provided between the common electrode 110 and the substrate 106. For example, by varying the thickness of the insulating layer 117 in the areas where the common electrode 110 overlaps the corresponding patch electrodes 108, the periodic change in the distance between the patch electrode 108 and the common electrode 110 can be adjusted. FIG. 7 shows a cross-sectional view of a configuration of a reflecting element in the radio-wave reflective device according to an embodiment of the present invention, and an inset view showing an enlarged view of the region where the patch electrodes 108 and the common electrode 110 overlap. For configurations that are identical or similar to those described with reference to FIG. 2B or FIG. 5, the description may be omitted.

The insulating layer 117 is provided between the common electrode 110 and the substrate 106. As a result, the distance between the common electrode 110 and the substrate 106 can be adjusted. In a region 119a where the patch electrode 108a overlaps the common electrode 110, the insulating layer 117 is thicker than in a region 119b where the patch electrode 108b overlaps the common electrode 110, and the common electrode 110 and the substrate 106 can be separated by a distance D8. By separating the common electrode 110 and the substrate 106 by the distance D8 in the region 119a, the distance between the patch electrode 108a and the common electrode 110 can be adjusted to the distance D1. At this time, the common electrode 110 has a uniform or substantially uniform thickness on the substrate 106.

In the region 119b where the patch electrode 108b and the common electrode 110 overlap, the insulating layer 117 is thicker than in the region where the patch electrode 108c and the common electrode 110 overlap, so that the common electrode 110 and the substrate 106 can be separated by a distance D9. In this case, as shown in FIG. 7, it is not necessary to provide the insulating layer 117 between the common electrode 110 and the substrate 106 in the region where the patch electrode 108c and the common electrode 110 overlap. Due to the distance D9 between the common electrode 110 and the substrate 106 in the region 119b, the patch electrode 108b and the common electrode 110 can be separated by the distance D2. The distance D2 between the patch electrode 108b and the common electrode 110 can be adjusted by the distance D9 between the common electrode 110 and the substrate 106 in the region 119b.

In a region where the patch electrode 108c and the common electrode 110 overlap, the insulating layer 117 may not be provided in the region where the patch electrode 108c and the common electrode 110 overlap, and the distance between the patch electrode 108c and the common electrode 110 may be set to the distance D3.

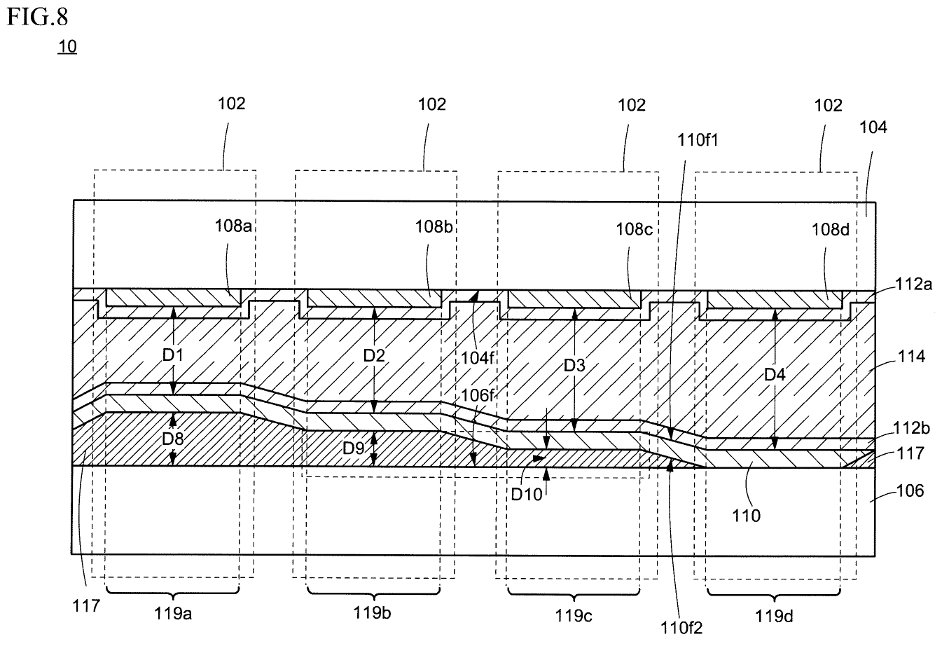

In addition, as described above, in the region 119c where the patch electrode 108c and the common electrode 110 overlap, as shown in FIG. 8, the insulating layer 117 may be thinner than in the region where the patch electrode 108b and the common electrode 110 overlap, and the common electrode 110 and the substrate 106 may be separated by a distance D10. Due to the distance D9 between the common electrode 110 and the substrate 106 in the region where the patch electrode 108c and the common electrode 110 overlap, the distance between the patch electrode 108c and the common electrode 110 can be adjusted to the distance D3.

The distances D8 to D10 indicate the distances between the common electrode overlapping the patch electrodes 108a to 108d, respectively, and the substrate 106, as described above. Specifically, the distance D8 indicates the distance between the surface 110f2 opposite the first surface 104f of the substrate 104 of the common electrode 110 and the first surface 106f of the substrate 106 in the region 119a where the patch electrode 108a and the common electrode 110 overlap. The distance D9 indicates the distance between the surface 110f2 opposite the first surface 104f of the substrate 104 of the common electrode 110 and the first surface 106f of the substrate 106 in the region 119b where the patch electrode 108b and the common electrode 110 overlap. The distance D10 indicates the distance between the surface 110f2 opposite the first surface 104f of the substrate 104 of the common electrode 110 and the first surface 106f of the substrate 106 in the region 119c where the patch electrode 108c and the common electrode 110 overlap.

The distances D1 to D3 are adjusted by different distances D8 to D10, and as described above, the distance between the patch electrode 108 and the common electrode 110 changes over a plurality of cycles, with distances D1 to D3 as one cycle.

### Modification 2 of First Embodiment

FIG. 2B shows an example in which the insulating layer 116 is provided between the patch electrode 108 and the substrate 104, and the distance between the patch electrode 108 and the common electrode 110 is periodically varied, but this example is not limited to this. For example, the distance between the patch electrode 108 and the common electrode 110 can be periodically varied by providing the insulating layer 116 between the patch electrode 108 and the substrate 104, and the insulating layer 117 between the common electrode 110 and the substrate 106.

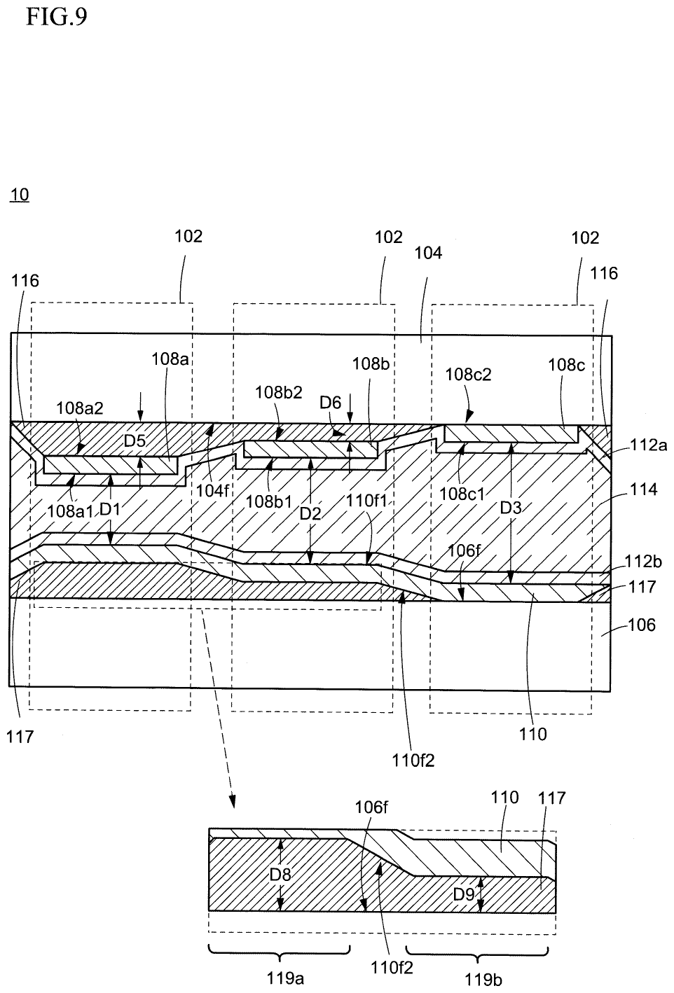

FIG. 9 shows a cross-sectional view of a configuration of a reflecting element in a radio-wave reflective device according to an embodiment of the present invention. For configurations that are identical or similar to those described with reference to FIG. 2B or FIG. 5, the description may be omitted.

As shown in FIG. 9, the distances D1 to D3 can be adjusted by the insulating layers 116 and 117.

As described above, in the present embodiment, by periodically varying the distance between the patch electrode 108 and the common electrode 110, it is possible to provide an initial phase difference in the reflected wave. Furthermore, by controlling the voltage applied to the patch electrode 108 and the common electrode 110, it is possible to change the dielectric constant of the liquid crystal layer 114 between the patch electrode 108 and the common electrode 110. As a result, it is possible to provide the radio-wave reflective device 100 that can compensate for the range of reflection directions of reflected waves that cannot be obtained by simply applying a voltage to the patch electrode 108 and the common electrode 110.

### Method 1 for Manufacturing Radio-Wave Reflective Device 100

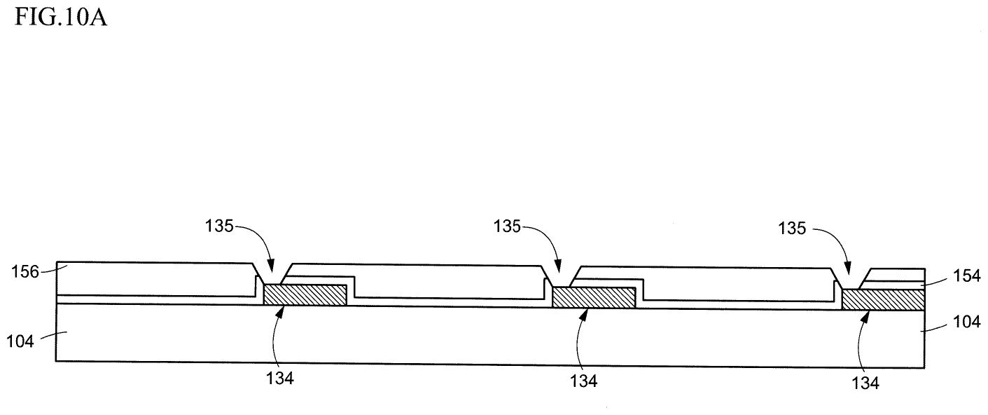

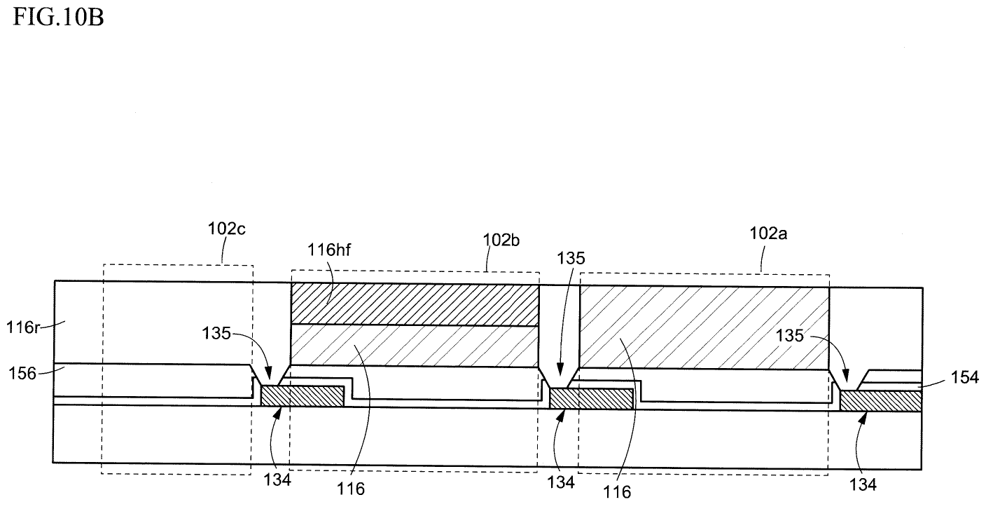

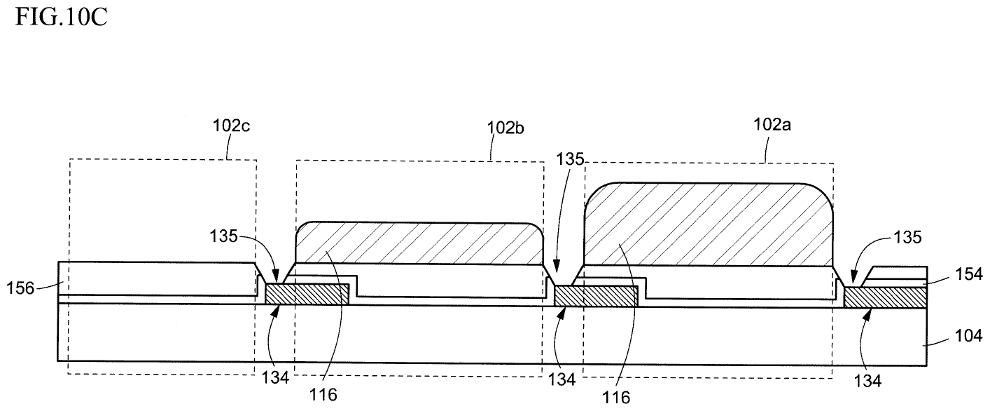

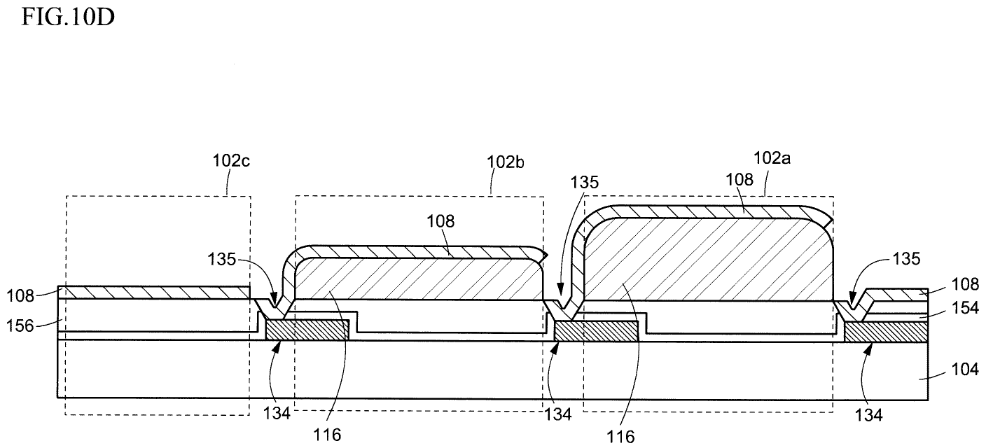

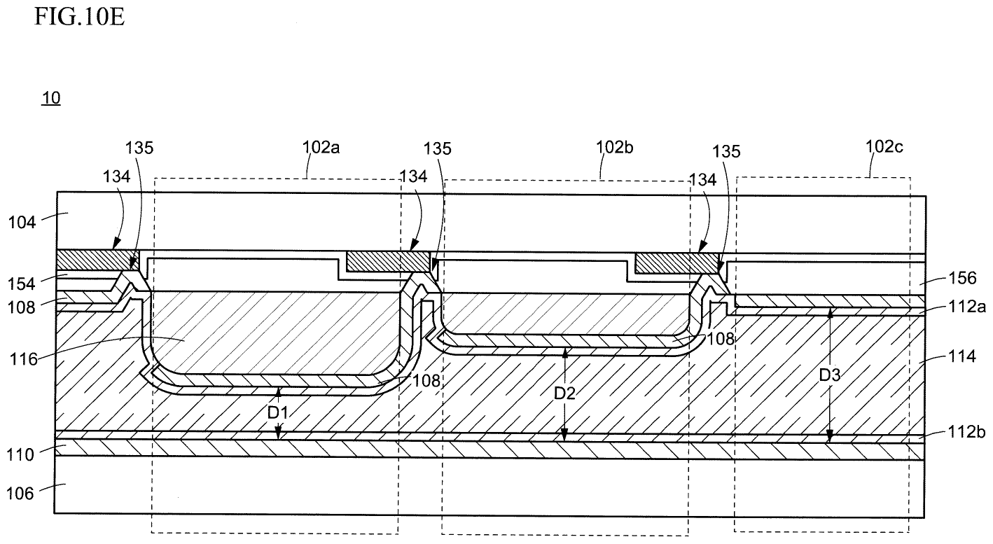

FIGS. 10A to 10E are cross-sectional views of the method for manufacturing the reflecting element 102 used in the radio-wave reflective device 100 shown in FIG. 2B of the first embodiment of the present invention.

First, as shown in FIG. 10A, a contact hole 135 that can be electrically connected to a switching element 134 is formed on a substrate 104 on which a switching element 134, an insulating layer 154, and an insulating layer 156 are formed.

Next, as shown in FIG. 10B, an organic photosensitive insulating film 116r is deposited on the switching element 134, the insulating layer 154, and the insulating layer 156, and the organic photosensitive insulating film 116r is exposed to form the insulating layer 116. At this time, as shown in FIG. 10B, the exposure conditions are set according to the magnitude of the For example, in the region of the initial phase difference. reflecting element 102a, where the initial phase difference is set to be small, the insulating layer 116 is exposed so that it remains thick, and in the region of the reflecting element 102b, where the initial phase difference is set to be larger than that of the reflecting element 102a and smaller than that of the reflecting element 102c, the insulating layer 116hf is exposed in halftone. In addition, the region of the reflecting element 102c, for which the initial phase difference is set to be larger than that of the reflecting elements 102a and 102b, is exposed so that the insulating layer 116 is not formed. The insulating layer 116 may be either a single-layer structure or a layered structure, and when the insulating layer 116 is made thick, it is desirable to use a layered structure for the insulating layer 116.

Next, as shown in FIG. 10C, the insulating layer 116 is developed and annealed.

Next, as shown in FIG. 10D, a metal layer containing a metal material constituting the patch electrode 108 is formed on the insulating layer 116 and the insulating layer 156, and then the patch electrode 108 is formed by performing an etching process on the metal layer.

Finally, as shown in FIG. 10E, an alignment film 112a is formed to cover the patch electrode 108 and the insulating layer 116, and the substrate 106 on which the common electrode 110 is formed is bonded thereto. Then, liquid crystal is injected between the substrate 104 and the substrate 106 to form the liquid crystal layer 114. As a result, the reflecting element 102 used in the radio wave reflective device 100 shown in FIG. 2B is completed.

### Method 2 for Manufacturing Radio-Wave Reflective Device 100

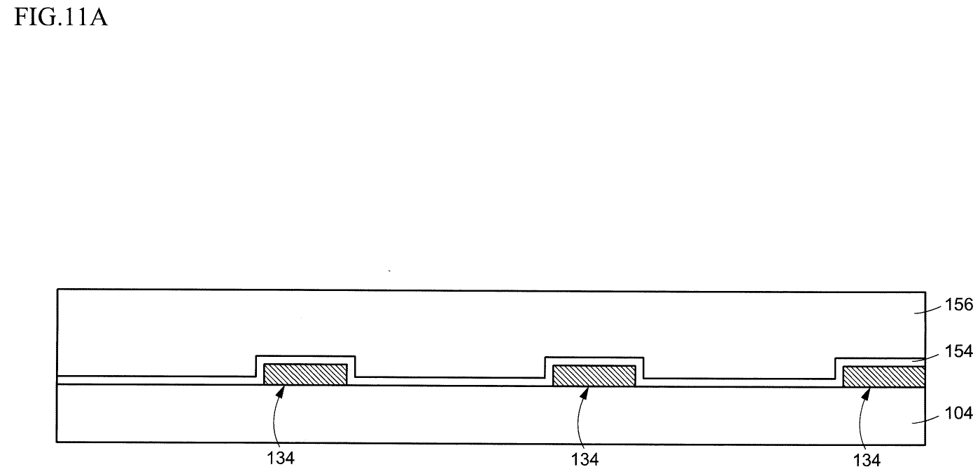

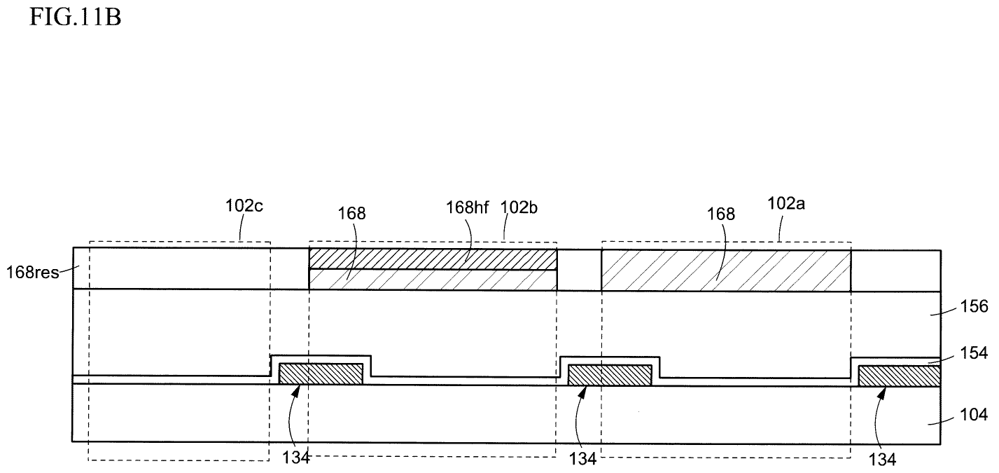

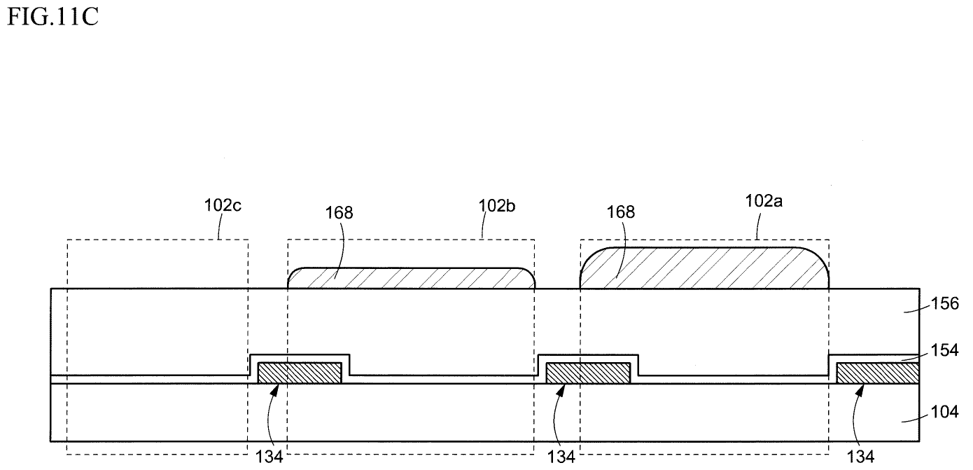

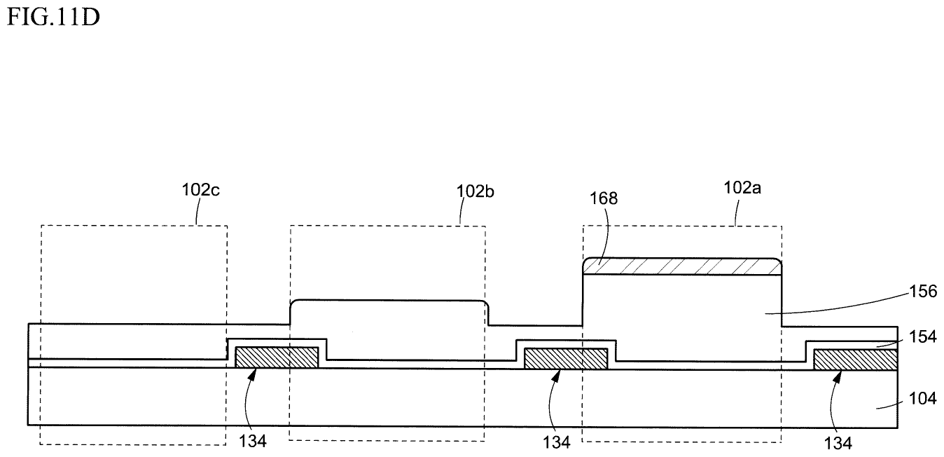

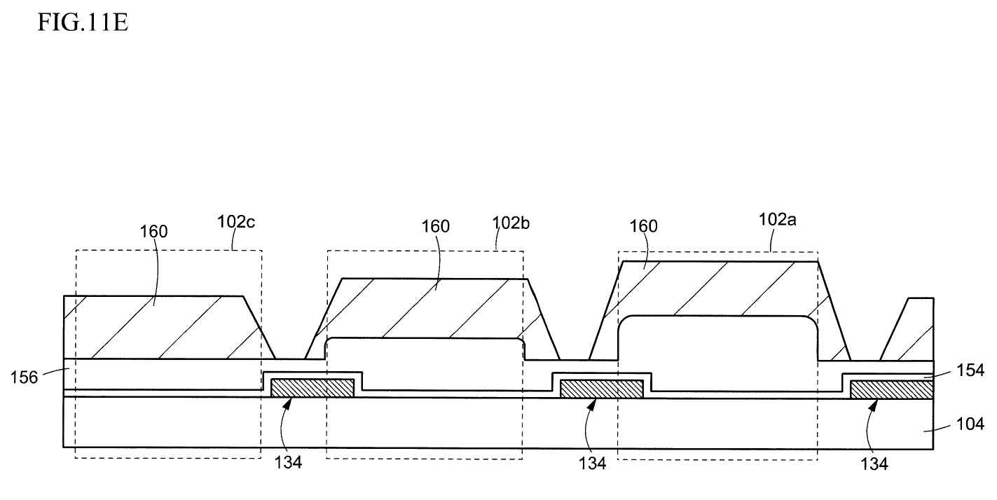

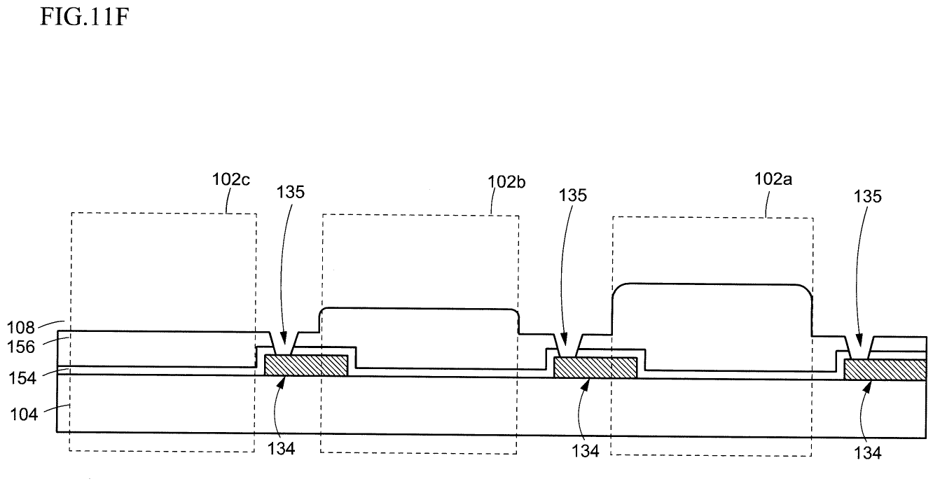

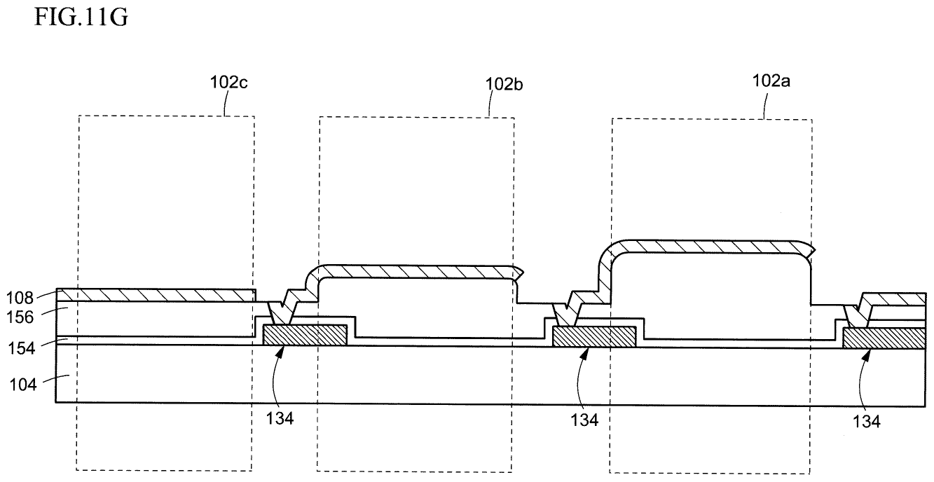

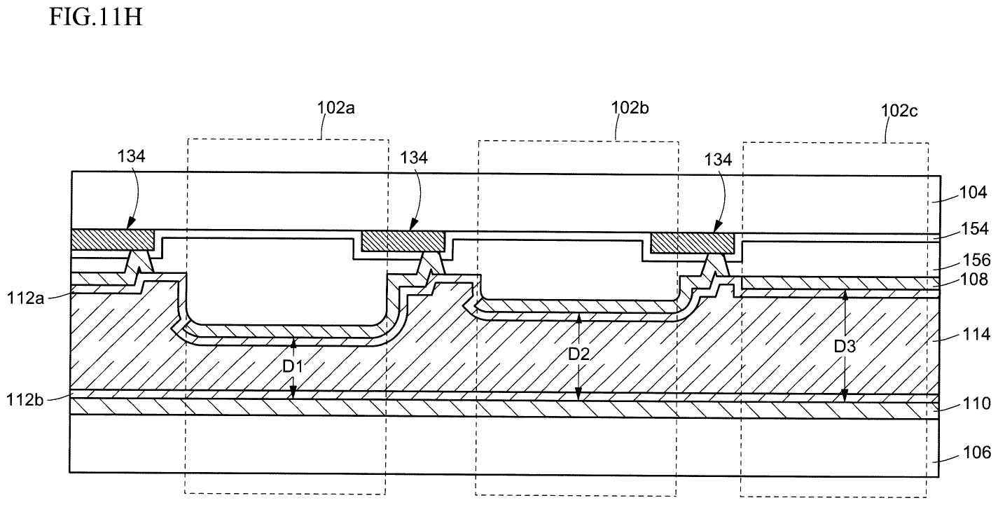

FIGS. 11A to 11H are cross-sectional views of a method for manufacturing the reflecting element 102 used in the radio wave reflective device 100 shown in FIG. 2B of the first embodiment of the present invention. Explanations of processes and configurations that are identical or similar to the method for manufacturing the reflecting element 102 used in the radio-wave reflective device 100 described above may be omitted.

First, as shown in FIG. 11A and FIG. 11B, a resist film 168res is coated on the substrate 104 on which the switching element 134, the insulating layer 154 on the switching element 134, and the insulating layer 156 on the insulating layer 154 are formed. The initial phase difference of the resist film 168 of the reflecting element 102 is adjusted to the desired thickness, and exposure is performed. For example, as shown in FIG. 11B, a large amount of the resist film 168 is formed in the region of the reflecting element 102a. In the region of the reflecting element 102b, halftone exposure is performed so that the resist film 168hf is formed thinner than the resist film 168 in the region of the reflecting element 102a. In the region of the reflecting element 102c, no exposure or exposure is not performed so that the resist film 168 is not formed.

Next, as shown in FIG. 11C, the resist film 168 is developed, and then annealed.

Next, as shown in FIG. 11D, the resist film 168 and the insulating layer 156 are dry-etched to form the insulating layer 156. In areas where the thickness of the resist film 168 formed on the insulating layer 156 is small, the resist film 168 is lost early as the dry etching progresses, and the etching of the insulating layer 156 proceeds. In areas where the thickness of the resist film 168 is large, the resist film 168 is lost later, and the etching of the insulating layer 156 proceeds. At the stage shown in FIG. 11D, the thickness of the insulating layer 156 has already become thin in areas where the resist film 168 has been lost, while the etching of the insulating layer 156 has not yet progressed in areas where the resist film 168 remains. Further etching may be performed such that the resist film 168 is completely removed, as shown in FIG. 11D, or the resist film 168 may be left partially intact to utilize it for forming a step in the portion of the reflecting element 102a. Here, the insulating layers of the reflecting elements 102a and 102b shown in FIG. 2B can be formed to include the insulating layer 156 as shown in FIG. 11D.

Next, as shown in FIG. 11E, a resist film 160 is deposited on the insulating layer 156, exposed, developed, and annealed to pattern the contact hole 135. As described above, the patch electrode 108 and the switching element 134 are electrically connected through this contact hole 135.

Next, as shown in FIG. 11F, the exposed insulating layer 156 by patterning the contact hole 135 is dry-etched and ashed to remove the resist film 160.

Next, the patch electrode 108 is formed as shown in FIG. 11G.

Finally, the substrate 104 and the substrate 106 are bonded together. As a result, the reflecting element 102 used in the radio-wave reflective device 100 shown in FIG. 2B is completed.

### Method 3 for Manufacturing Radio-Wave Reflective Device 100

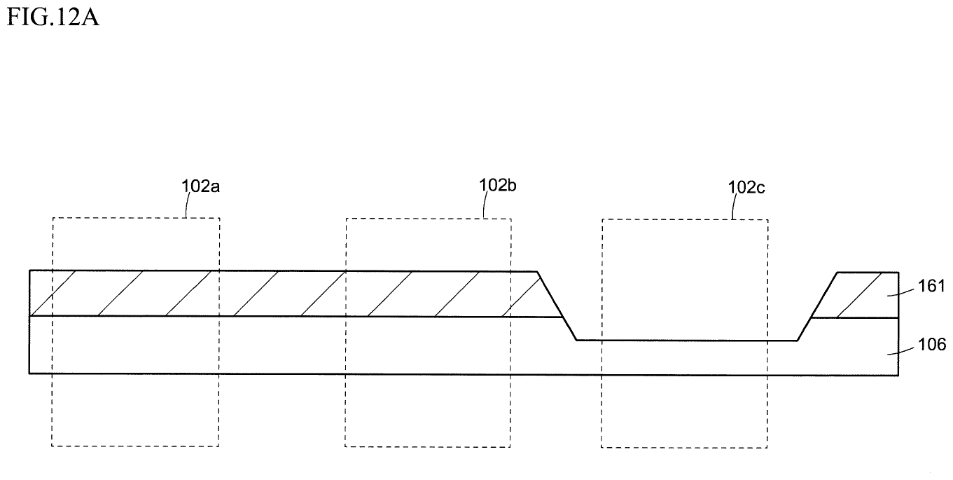

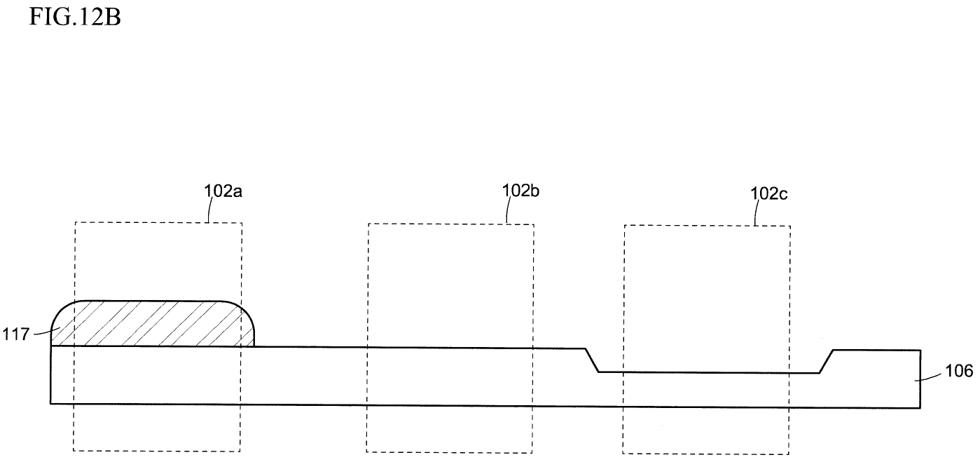

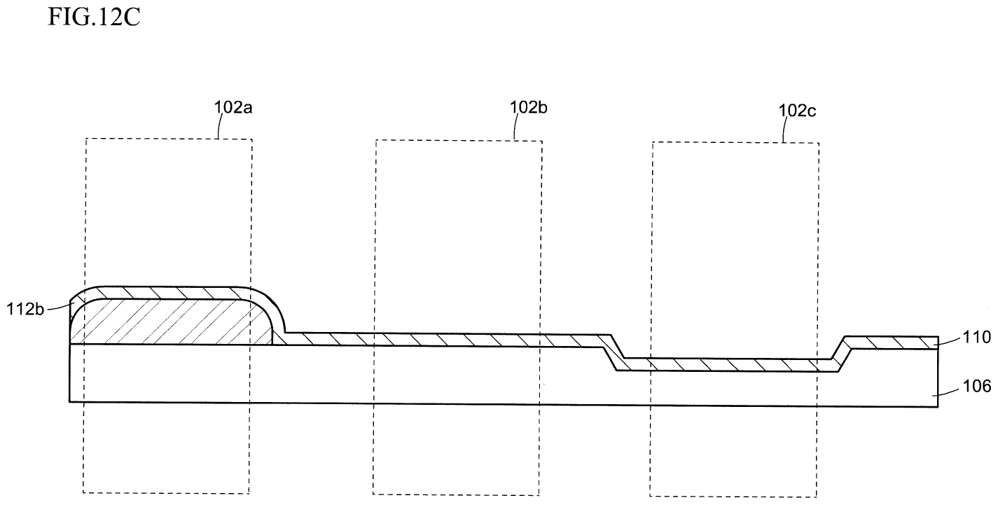

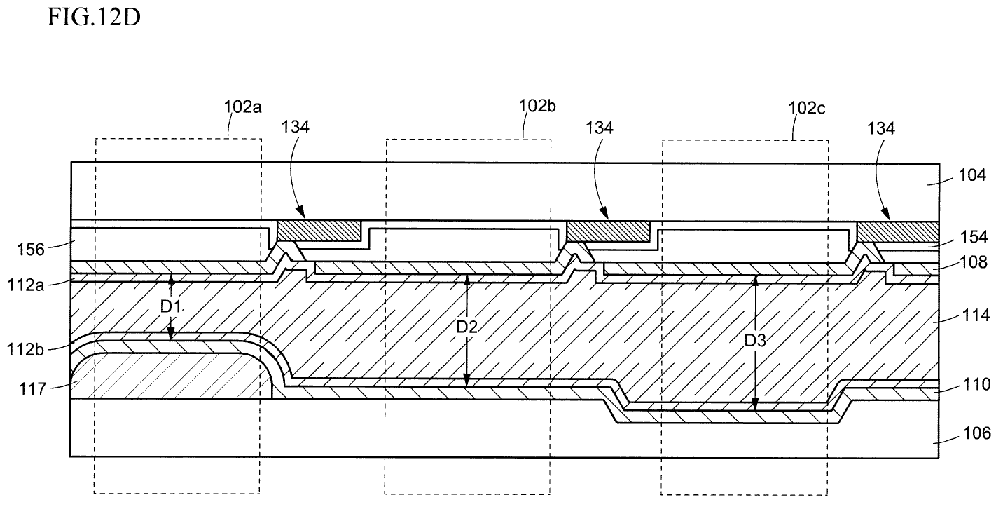

FIGS. 12A to 12D are cross-sectional views of a method for manufacturing the reflecting element 102 in which the distance between the patch electrode 108 and the common electrode 110 is adjusted by the insulating layer 117 between the common electrode 110 and the substrate 106. Explanations of processes and configurations that are identical or similar to the method for manufacturing the reflecting element 102 used in the radio-wave reflective device 100 described above may be omitted.

First, patterning is performed in the region where the reflecting element 102c with a large initial phase difference is formed. The resist film 161 is deposited on the substrate 106, exposed, developed, and baked. As shown in FIG. 12A, the substrate 106 is etched. In FIG. 12A, the substrate 106 in the region where the reflecting element 102c is formed is etched, but the region of the substrate 106 where the reflecting element 102b is formed may be patterned and etched. At this time, the recesses formed in the reflecting element 102b may be etched to a shallower depth than the recesses formed in the reflecting element 102c.

FIG. 12A shows an example of forming a recess in the substrate 106 to obtain the distance D3 between the patch electrode 108c and the common electrode 110 of the reflecting element 102c. Regarding configurations that modify the distance between the patch electrode 108 and the common electrode 110, this is not limited to forming the above-mentioned recess. Instead, the distance between the patch electrode 108 and the common electrode 110 may be varied by forming the insulating layer 117 using an organic or inorganic film with different thicknesses on the substrate 106. For example, as shown in FIG. 5, the substrate 106 is not etched, and the insulating layer 117 of the reflecting element 102a and the reflecting element 102b is formed on the substrate 106, and the insulating layer 117 is not formed in the region where the reflecting element 102c is formed. In this case, since the distance D1 is shorter than the distance D2, the thickness of the insulating layer 117 of the reflecting element 102a may be formed to be thicker than that of the insulating layer 117 of the reflecting element 102b. Furthermore, the insulating layer 117 may be either a single-layer structure or a multilayer structure. When the insulating layer 117 is formed to be thick, it is preferable to use a multilayer structure for the insulating layer 117, and a combination of organic and inorganic films may also be used.

Next, the resist film 161 is removed, the insulating layer 117 is patterned on the substrate 106, and annealing is performed. In FIG. 12B, the insulating layer 117 is patterned in the region where the reflecting element 102a is formed on the substrate 106, and annealing is performed. At this time, it is desirable to appropriately determine the depth of the recess in the region where the reflecting element 102c is formed and the thickness of the insulating layer 117 in the region where the reflecting element 102a is formed, based on the region where the reflecting element 102b, which has an intermediate length between the patch electrode 108 and the common electrode 110, is formed among the reflecting elements 102a to 102c.

Next, the common electrode 110 is formed on the insulating layer 117 and the substrate 106.

Finally, the substrate 104 and the substrate 106 are bonded together. As a result, a reflecting element 102 is completed, in which the distance between the patch electrode 108 and the common electrode 110 is adjusted by the insulating layer 117 between the common electrode 110 and the substrate 106 using the radio-wave reflective device 100.

### Second Embodiment

In the first embodiment, an example of one-dimensional control in which the traveling direction of the reflected wave is changed in the second direction with the reflection axis VR as the rotation axis was described. In the present embodiment, an example of two-dimensional control in which the traveling direction of the reflected wave is also changed in the first direction with a reflection axis HR as the rotation axis is described. Elements having the same functions as those in the first embodiment are indicated with the same reference signs, and redundant explanations are omitted.

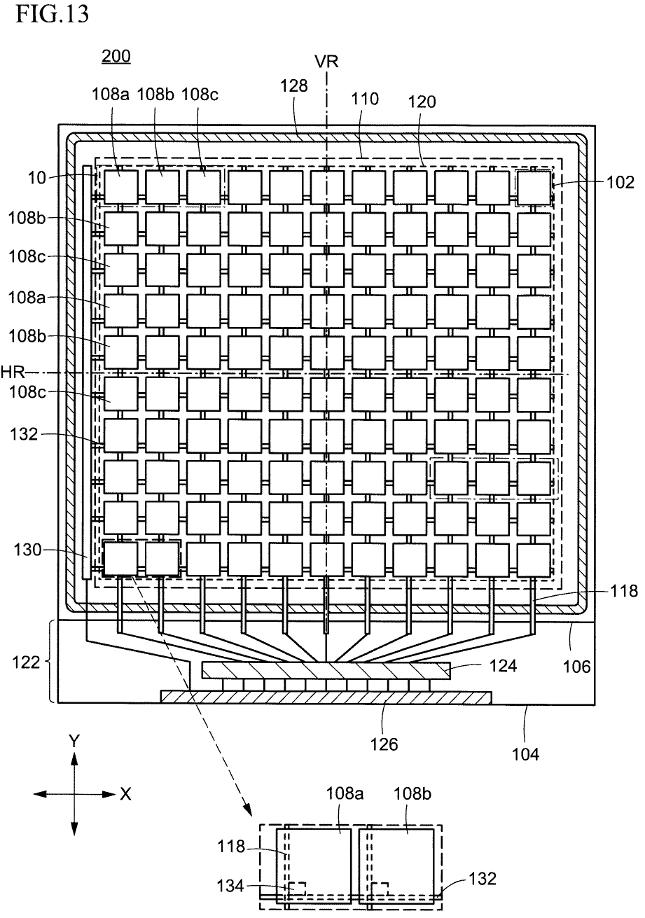

FIG. 13 is a plan view showing a radio-wave reflective device 200 of an embodiment of the present invention. The radio-wave reflective device 200 of the present embodiment has a plurality of second wirings 132 that extend in the second direction (row direction or Y direction) as well as in the first direction (column direction or X direction), in addition to the plurality of first wirings 118 that extend in the first direction (column direction) as well as in the second direction. The plurality of first wirings 118 and the plurality of second wirings 132 intersect with an insulating layer not shown therebetween. The plurality of first wirings 118 are connected to the first drive circuit 124 that outputs control signals. The plurality of second wirings 132 are connected to a second drive circuit 130 that outputs scanning signals.

As shown in the enlarged view in FIG. 13, each reflecting element 202 includes a switching element 134. In the present embodiment, the switching element 134 is a transistor. However, the present embodiment is not limited to this example and the switching element 134 may be any element that functions as a switch. In addition, in the enlarged view, although the reflecting element 202 including the patch electrode 108a is shown as an example, the reflecting element 202 including the patch electrode 108b or 108c has the same configuration.

The switching element 134 is connected to the first wiring 118 and the second wiring 132. Specifically, the first wiring 118 is connected to a source of the transistor that is the switching element 134, and the second wiring 132 is connected to a gate. A switching function of the switching element 134 is controlled by the scanning signal supplied to the second wiring 132. When the switching element 134 is turned on, the patch electrode 108 and the first wiring 118 are electrically connected and the control signal is supplied to the patch electrode 108. According to this configuration, the plurality of patch electrodes 108 arranged in the second direction can be selected row by row, and control signals of different voltages can be supplied to each row.

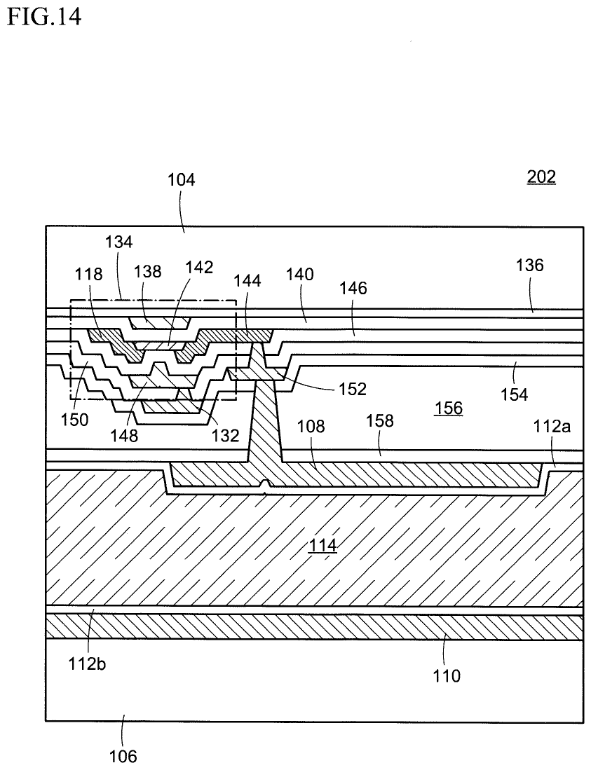

FIG. 14 is a cross-sectional view of the reflecting element 202 of the radio-wave reflective device 200 of another embodiment of the present invention. The switching element 134 includes a first gate electrode 138, a first gate insulation layer 140, a semiconductor layer 142, a second gate insulation layer 146, and a second gate electrode 148. An undercoat layer 136 is arranged between the first gate electrode 138 and the substrate 104.

The first wiring 118 and a first connection wiring 144 are arranged between the first gate insulating layer 140 and the second gate insulating layer 146. The first wiring 118 and the first connection wiring 144 are arranged in contact with the semiconductor layer 142. Specifically, the first wiring 118 is connected to a source side of the semiconductor layer 142, and the first connection wiring 144 is connected to a drain side of the semiconductor layer 142. However, the positional relationship of the source and drain may be reversed according to the voltage applied between the source and drain of the transistor.

The switching element 134 is covered by a first interlayer insulating layer 150. The second wiring 132 is arranged on the first interlayer insulating layer 150. The second wiring 132 is connected to the second gate electrode 148 through a contact hole formed in the first interlayer insulation layer 150. In addition, although not shown in the drawing, the first gate electrode 138 and the second gate electrode 148 are electrically connected to each other in a region that does not overlap the semiconductor layer 142. On the first interlayer insulating layer 150, a second connection wiring 152 is arranged in the same conductive layer as the second wiring 132. The second connection wiring 152 is connected to the first connection wiring 144 through a contact hole formed in the second gate insulating layer 146 and the first interlayer insulating layer 150.

The second wiring 132 and the second connection wiring 152 are covered by an insulating layer 154. On top of the insulating layer 154, a planarization layer 156 (an insulating layer 156) is provided to fill steps formed by the switching element 134. By providing the planarization layer 156, the patch electrode 108 can be formed without being affected by undulations caused by the arrangement of the switching element 134. A passivation layer 158 is provided above the planarization layer 156. The patch electrode 108 is arranged over the passivation layer 158. The patch electrode 108 is connected to the second connection wiring 152 through a contact hole that penetrates the passivation layer 158, the planarization layer 156, and the insulating layer 154. The alignment film 112a is arranged over the patch electrode 108.

On the substrate 106, the common electrode 110 and the alignment film 112b are arranged as in FIG. 2B of the first embodiment. The surface on the opposing substrate 106 on which the common electrode 110 is provided is arranged to face a surface on which the patch electrode 108 is provided on the substrate 104. The liquid crystal layer 114 is arranged between the alignment film 112a and the alignment film 112b.

In the structure shown in FIG. 14, the undercoat layer 136 is formed of, for example, a silicon film. The first gate insulating layer 140 and the second gate insulating layer 146 are formed of, for example, a silicon oxide film or a stacked structure of a silicon oxide film and a silicon nitride film. Semiconductor layers are formed of, for example, silicon semiconductors such as amorphous silicon and polycrystalline silicon, and oxide semiconductors including metal oxides such as indium oxide, zinc oxide, and gallium oxide. The first gate electrode 138 and the second gate electrode 148 are formed of, for example, molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), or molybdenum (Mo). For example, each wiring may be composed of a stacked structure of titanium (Ti)/aluminum (Al)/titanium (Ti) or a stacked structure of molybdenum (Mo)/aluminum (Al)/molybdenum (Mo). The planarization layer 156 is formed using a resin material such as acrylic, polyimide, or the like. The passivation layer 158 is formed using, for example, a silicon nitride film. The patch electrode 108 and the common electrode 110 are formed using a metal film such as aluminum (Al), copper (Cu), or a transparent conductive film such as indium tin oxide (ITO).

As shown in FIG. 14, the second wiring 132 is connected to the gate of the transistor used as the switching element 134, the first wiring 118 is connected to one of the source and drain of the transistor, and the patch electrode 108 is connected to the other of the source and drain. This allows the control signal to be supplied by selecting a predetermined patch electrode from the plurality of patch electrodes 108 arranged in a matrix.

Thus, the radio-wave reflective device 200 can control the voltage applied to the patch electrodes 108 for each reflecting element 202. Therefore, not only can the applied voltage be made different between patch electrodes 108 adjacent to each other in the second direction, but also the applied voltage can be made different between patch electrodes 108 adjacent to each other in the first direction. In other words, the radio-wave reflective device 200 of the present embodiment has a function of controlling the traveling direction of the reflected wave in the first direction around the reflection axis HR in addition to a function of controlling the traveling direction of the reflected wave in the second direction around the reflection axis VR.

In addition, in the radio-wave reflective device 200 of the present embodiment, by making areas of the patch electrodes 108 adjacent to each other in the first direction different, a phase of reflected waves in each reflecting element 202 including the respective patch electrodes 108a to 108c can be made different even in the initial state. In other words, similar to the radio-wave reflective device 100 of the first embodiment, the radio-wave reflective device 200 of the present embodiment is set in the initial state so that the traveling direction of the reflected wave relative to the incident wave is inclined in the first direction (column direction) in advance. Therefore, in the present embodiment, the traveling direction of the reflected wave inclined in the first direction in the initial state can be further changed to the first or second direction by voltage control.

For example, in the example shown in FIG. 7, since the reflected wave is preset to head in the first direction in the initial state, voltage control can further change the traveling direction of the reflected wave from the preset direction to the first direction. By performing such control, the radio-wave reflective device 200 can send radio waves to locations where radio waves cannot be sent by voltage control alone.

The configuration of each of the above embodiments (including modifications) shown as an embodiment of the present invention can be combined as appropriate as long as they do not contradict each other. In addition, any addition, deletion, or design change of components, or any addition, omission, or change of conditions of processes, made by a person skilled in the art based on the configuration of each embodiment disclosed in this specification and the drawings, is also included in the scope of the invention as long as it has the gist of the invention.

Other effects different from those brought about by the embodiments disclosed herein, which are obvious from the description herein or which can be easily predicted by those skilled in the art, are naturally understood to be brought about by the present invention.

What is clamed is:

1. An intelligent reflecting surface comprising:
a plurality of patch electrodes;
a common electrode opposite the plurality of patch electrodes; and
a liquid crystal layer between the plurality of patch electrodes and the common electrode,
wherein the plurality of patch electrodes comprises a first patch electrode and a second patch electrode adjacent to the first patch electrode,
a first distance between the first patch electrode and the common electrode is shorter than a second distance between the second patch electrode and the common electrode,
the first distance is a distance from a first surface opposite the common electrode of the first patch electrode to a surface opposite the first patch electrode of the common electrode, and
the second distance is a distance from a first surface opposite the common electrode of the second patch electrode to a surface opposite the second patch electrode of the common electrode.

2. The intelligent reflecting surface according to claim 1, wherein
the plurality of patch electrodes further comprises a third patch electrode adjacent to the second patch electrode,
a third distance between the third patch electrode and the common electrode is longer than the second distance, and
the third distance is a distance from a first surface opposite the common electrode of the third patch electrode to a surface opposite the third patch electrode of the common electrode.

3. The intelligent reflecting surface according to claim 2, wherein
a phase difference between a reflected wave by a first reflecting element including the first patch electrode and a reflected wave by a second reflecting element including the second patch electrode is the same as a phase difference between a reflected wave by the second reflecting element and a reflected wave by a third reflecting element including the third patch electrode.

4. The intelligent reflecting surface according to claim 1, wherein
the plurality of patch electrodes is arranged on a first surface of a first substrate,
a fourth distance between the first patch electrode and the first substrate is longer than a fifth distance between the second patch electrode and the first substrate,
the fourth distance is a distance from a second surface opposite to a first surface of the first patch electrode to the first surface of the first substrate, and
the fifth distance is a distance from a second surface opposite to a first surface of the second patch electrode.

5. The intelligent reflecting surface according to claim 4, wherein
the plurality of patch electrodes further comprises a third patch electrode adjacent to the second patch electrode,
the third patch electrode has a first surface opposite the common electrode,
a sixth distance between the third patch electrode and the first substrate is shorter than the fifth distance, and
the sixth distance is a distance from a second surface opposite to a first surface of the third patch electrode to the first surface of the first substrate.

6. The intelligent reflecting surface according to claim 1, wherein
the plurality of patch electrodes is arranged on a first surface of a first substrate,
the common electrode is arranged on a first surface of a second substrate opposite the first substrate, and
a distance between a surface opposite the first surface of the second substrate of the common electrode and the first surface of the second substrate is different in a region where the second patch electrode and the common electrode overlap.

7. The intelligent reflecting surface according to claim 6, wherein
the plurality of patch electrodes further comprises a third patch electrode adjacent to the second patch electrode, and
a distance between a surface opposite the first surface of the second substrate of the common electrode and the first surface of the second substrate is different in a region where the common electrode overlaps the first patch electrode, a region where the common electrode overlaps the second patch electrode, and a region where the common electrode overlaps the third patch electrode.

8. The intelligent reflecting surface according to claim 4, wherein
the common electrode is arranged on a first surface of a second substrate, and
a distance between a surface opposite the first surface of the second substrate of the common electrode and the first surface of the second substrate is different in a region where the common electrode overlaps the first patch electrode and a region where the common electrode overlaps the second patch electrode.

9. The intelligent reflecting surface according to claim 8, wherein
the plurality of patch electrodes further comprises a third patch electrode adjacent to the second patch electrode, and
a distance between a surface opposite the first surface of the second substrate of the common electrode and the first surface of the second substrate is different in a region where the common electrode overlaps the first patch electrode, a region where the common electrode overlaps the second patch electrode and a region where the common electrode overlaps the third patch electrode.

10. The intelligent reflecting surface according to claim 1, wherein
the plurality of patch electrodes is arranged in a matrix, and
the plurality of patch electrodes is connected for each array in a column direction.

11. The intelligent reflecting surface according to claim 1, further comprising a transistor, wherein
the plurality of patch electrodes is arranged on a first surface of a first substrate, and
the transistor is provided on the first substrate.
